(19) United States
(12) Patent Application Publication
(10) Pub. No.: US 2003/0080527 A1
(43) Pub. Date: May 1, 2003

(54) Opposing spring rebound tension suspension system

(76) Inventor: Peter E. Bryant, Las Vegas, NV (US)

Correspondence Address: AARON PASSMAN, 9632 WINDOM POINT AVE., LAS VEGAS, NV, 89129, US

(21) Appl. No.: 10/033,016

(22) Filed: Oct. 26, 2001

(51) Int. Cl. B60G 11/12

(52) U.S. Cl. 280/124.175

(57) ABSTRACT

A suspension system for chassis and/or body sprung weight and a plurality of wheel axle supports to carry a portion of the unsprung weight. The system has a load leaf spring between the chassis and/or body and wheel axle support preloaded to a ride height. A rebound member between the wheel axle support and the chassis and/or body exerts increasing force with motion of the unsprung weight relative to the chassis and/or body. The rebound member has increasingly less force on the load spring during jounce beyond the ride height as the member resists the motion of unsprung weight. The rebound member free length of travel cooperates with the load spring jounce deflection so the travel and the deflection overlap as the member moves.

This relates to an opposing spring suspension including a rebound tension member between the chassis and/or body and each wheel axle support. More particularly, each rebound tension member uses the unsprung weight of the wheel/axle to aid the sprung mass of the chassis resist the rebound travel of the suspension and so reduce the chassis and/or body side sway and pitching forward and aft due to hard acceleration and deceleration. The end result is that the sprung mass becomes suspended between two opposing springs and thus finds resistance to both jounce and rebound suspension travel.

### BACKGROUND OF THE INVENTION

In the past ten years the numbers of sport utility vehicles “SUV” and pickup trucks have increased dramatically to the point where those vehicles are more popular than the millions of passenger cars on the road. The SUV and trucks inherently have a higher center of gravity than normal passenger cars due to the need for higher ground clearance for bad weather travel (snow and ice), off-road use and/or for pickup truck payloads. Typically these vehicles have a higher center of gravity and so a greater propensity to sway or even rollover during abrupt lane changes and evasive steering maneuvers than the lower normal passenger cars.

One important arrangement of all these vehicles is the method of suspension used. Except for the use of hydraulic shock absorber damping resistance to rebound, all suspension have the vehicle chassis and body load supported on the vehicle axles with various types of springs that resist primarily load and jounce of each wheel axle. All existing coil springs, load leaf springs, air springs, torsion bars or rubber blocks suspensions have no provision for control of the rebound forces of inertia and gravity negative suspension loads. Particularly, those rebound loads occurring at the inside wheel during hard cornering or if a wheel drops into a pot-hole.

Typically, changes in suspension loads while driving straight along a road are caused generally by reactions to bumps, pot-holes, and roughness encountered by the vehicle wheels during their interaction with the road surface. Thus the suspension springs and associated shock absorbers quell the harshness and movements being transmitted to the body/chassis.

The sway or side to side rolling motions that vehicles experience due to cornering forces, also cause vehicle springs to be loaded or unloaded, depending which way the vehicle is rolling during cornering. Many vehicles have an anti-sway/roll bar installed to help the vehicle body resist the rolling actions. These devices help somewhat the vehicle resist roll but only as it relates to the body lean, because they are fixed to the sprung mass and leaning with the body. Thus, they actually reduce the load on the unloaded side of the vehicle. They use the body as a structure to support the torsion bar of the anti sway system transferring wheel jounce motion across to the opposite side. The disclosure herein will obviate the need for anti-sway bars saving the cost of providing and installing them. Shock absorbers only dampen the bouncing movement of the vehicle wheels and suspension caused by the reaction to road surface, cornering and braking. Thus, the rate of sway may be affected to a minor degree.

The transitory effects of body roll during cornering flex the springs on the side of the vehicle following the outside of the turn due to increased transfer weight to that side. Meanwhile the springs on the side of the vehicle, following the inside of the turn, unload extending toward their free position using the axle as a location for inducing lift of the sprung weight on that side resulting in increased body roll. Roll or sway during sudden cornering or evasive maneuvers rotates the vehicle and its center of gravity “CG” around the Roll Center axis. The Roll Center axis is a function of the particular vehicle's suspension geometry. Roll or sway is increased if the vehicle center of gravity is raised as in a SUV, four-wheel drive vehicle or truck. A sudden turn opposite the direction of vehicle travel can cause momentum to continue the sway of the vehicle forcing its center of gravity to move laterally past its maximum upright position, and so the vehicle continues on rolling and overturns.

U.S. Pat. No. 2,160,541 has a paired spring suspension connected in series to only support load and jounce with the added spring coupled in line with the main spring for increasing the effective spring constant at the extremes of suspension travel. The techniques disclosed in the various embodiments of '541 are in the nature of an overload spring that engages and changes the spring constant at the extremes of wheel travel. There is no spring in '541 connected to specifically resist rebound forces due to diverging motion of the sprung weight to unsprung weight. The disclosure of '541 specifically states that the higher spring constant results in less flex (on page 2 column 1 at lines 6 to 8), “. . . which opposes any tendency of the vehicle to overturn laterally when negotiating a turn.” In each embodiment of '541 the springs act in unison to control primarily load and jounce and there is no teaching of a particular connection to directly apply rebound reaction of unsprung weight to one of the springs. The graph in '541 showing wheel travel verses spring forces verifies these conclusions. U.S. Pat. No. 5,263,695 discloses a refinement of the '541 teaching that includes a shock absorber for damping motion and an elastic block to ameliorate the transition between first and second springs for carrying the load. In addition to many disclosures in '695 of prior paired spring configurations there is a specific explanation in column 5, lines 1 through 5 as follows:

“The suspension according to the invention produces a comfort level which is higher the more the transition from one stiffness to the other takes place progressively (see the patents cited in the state of the art).”

The state of the art referred to includes prior patents of the same inventor and the acknowledgements of those prior patents clearly identifies the teachings as merely two springs of different stiffness in series. Even in FIG. 7 of '695 the springs are concentrically mounted but act in series, see column 4, lines 8 through 12. At best the structures for multiple springs shown in these patents have differing spring rates to give an allegedly more comfortable ride. No existing suspension system suspends the chassis and/or body between opposing springs to counter load and jounce and reaction and rebound along different portions of the axle and wheel travel. An opposing spring suspension can have little effect on the ride stiffness but stabilizes cornering and evasive maneuvering sway by helping the vehicle to resist roll while maintaining the general ride quality.

U.S. Pat. No. 6,273,441 has a load leaf spring suspension system with an elongated stabilizing spring mounted there above the axle. The added spring communicates roll resistance to the vehicle axle at its top center section. Force is concurrently applied at the ends of the stabilizing spring to the leaf spring of the vehicle by shackles. Adjustment of the device is achieved by use of a plurality of mounting apertures for the shackles located at varying distances from the center of the stabilizing spring thereby allowing for adjustment by the user for desired performance characteristics. Further force adjustment is achieved with one or a combination of an optional axle spacer located at the center section of the stabilizing spring to communicate with the axle. This stabilizer system does not employ opposing spring technology.

An influence is delivered on the vehicle center of gravity by opposing spring. The center of gravity of the unsprung mass relative to the center of gravity of the sprung mass is affected during the cornering maneuvers. Without a tension or opposing spring to “tether” the sprung mass to the unsprung mass the unsprung mass does not initially help resist the movement upwards of the sprung mass. This resistance is best appreciated in a vehicle with very heavy unsprung mass relative to a lighter sprung mass during cornering versus a vehicle with light unsprung mass relative to a heavy sprung mass. The former is recognized as undesirable and the latter is greatly preferred and sought after in design of vehicles. Often the physical limits of the vehicle components determine the practical boundaries of the sprung weight to unsprung weight ratio. The disclosure herein has an approach to ameliorate the dynamics of that relationship.

### SUMMARY OF THE INVENTION

A vehicle opposed spring system is preferably placed between a chassis and/or body having a sprung weight and a plurality of wheel axle supports each carrying a portion of an unsprung weight. The opposed spring system may include a load leaf spring mounted between the chassis and/or body and the wheel axle support to carry when preloaded the chassis and/or body at a preset ride height relative to the wheel axle support. The load leaf spring affixed between each wheel axle support and the chassis and/or body preferably exerts increasing force there between primarily as a function of the amount of jounce motion of the unsprung weight relative to the chassis and/or body. A rebound member is also preferably a spring mounted to move between the chassis and/or body and the wheel axle support. The rebound member most preferably applies increasingly less force to the load leaf spring during jounce beyond the preloaded preset ride height of the load leaf spring. The rebound member increasingly resists the rebound travel of the sprung weight on the wheel axle support. Rebound travel is the motion of the sprung mass that occurs as the compression suspension spring is unloading beyond the designed height suspension position.

The rebound member has a free length of travel that operates in cooperation with the load leaf spring jounce deflection and the free length of travel and the jounce deflection may overlap when the rebound member flexes (moves) between the chassis and/or body and the wheel axle support. The chassis and/or body preferably has a substantially rectangular footprint having four wheels disposed generally to carry the corners thereof with each corner having its wheel axle support moveably carried by its load leaf spring and its rebound member to resist jounce and rebound, respectively. A shock absorber can be located between and affixed to the chassis and/or body for each wheel axle support for damping the jounce and rebound motions there between progressively decreasing the frequency of the wheel axle support motion.

The rebound member is preferably a rebound leaf spring not directly attached and/or shackled to the chassis and/or body but clamped and shackled preferably beneath and adjacent to the load leaf spring to distribute force during rebound motion of the axle support to the chassis and/or body. The rebound member can also be a coil spring having its free length of travel preloaded with tension sufficient to maintain its connection between the chassis and/or body and the wheel axle support even when the load leaf spring is flexed to its maximum load capacity. The rebound member alternatively might be a pair of opposed coil springs separated by a platform and carried by a rod so their travel is controlled sufficiently between the chassis and/or body and the wheel axle support as the load leaf spring is flexed. The rebound member could be a torsion spring with torque preloaded sufficiently between the chassis and/or body and the wheel axle support to control rebound and/or maintain connection there between even when the load leaf spring is flexed to its maximum load capacity.

The load leaf spring preferably has an elastic constant of K to carry sprung weight on the wheel axle support and the rebound member has an elastic constant K_{T} for resisting the rebound motion of the sprung weight over the wheel axle support. The relationship of the elastic constant of K to carry sprung weight for jounce and the elastic constant K_{T} for resisting the rebound motion of the sprung weight is a function of the amount of roll resistance.

An alternative may have a plurality of coil control springs affixed between each wheel axle support and the chassis and/or body for exerting increasing force thereat as a function of the amount of rebound motion of the sprung weight relative of the chassis and/or body. Each coil control spring can oppose its respective load leaf spring applying increasingly less rebound force thereto during jounce through and beyond the preset ride height of the load leaf spring as each respective coil control spring controls the rebound motion of sprung weight over its respective wheel axle support. A path or load axis is preferably defined for each wheel axle support along a line between the chassis and/or body and the wheel axle support. Along each path each load leaf spring and its respective coil control spring jounce and rebound. The coil control spring has preferably has a free length of travel that cooperates with the load leaf spring jounce deflection along the path or axis of loading so the free length of travel along the path and the jounce deflection along the path overlap.

Each wheel axle support may have a rod fixed to the chassis and/or body extending along the line for supporting a suspension platform. Each suspension platform is most preferably disposed between compression coils for platform reciprocation along the path axis of loading to control primarily rebound of the load leaf spring as the suspension platform is affixed to the wheel axle support.

The opposing spring suspension preferably has two opposing springs that seek to keep the vehicle chassis and/or body mass stabilized in a predetermined sprung position of height relative to the wheel axle system of the vehicle. This sprung position is preferably arrived at by using at least a leaf spring of a known rate per inch for jounce against with another rebound spring also of a known rate per inch, that through their opposition and relative pre-load with respect to one another, position chassis/body at a neutral location arrived at as the result of the sum of the opposing forces. A simpler illustration of what happens can be understood by imagining a paper clip suspended between two extended rubber bands stretched in opposite directions tethering the clip between their ends. Motion of the paper clip toward one rubber band end would shorten that rubber band and lengthen the other. Releasing the tension on the paper clip returns it to its former location between the two stretched bands. This simple demonstration shows how the vehicle has the capability to quickly return to a constant ride height position relative to the ground. This capability should vastly reduce the tasks to be performed by the standard equipment shock absorbers of the vehicle and in fact increase shock absorber life expectancy dramatically, due mainly to reduced use and associated heat.

### BRIEF DESCRIPTION OF THE INVENTION

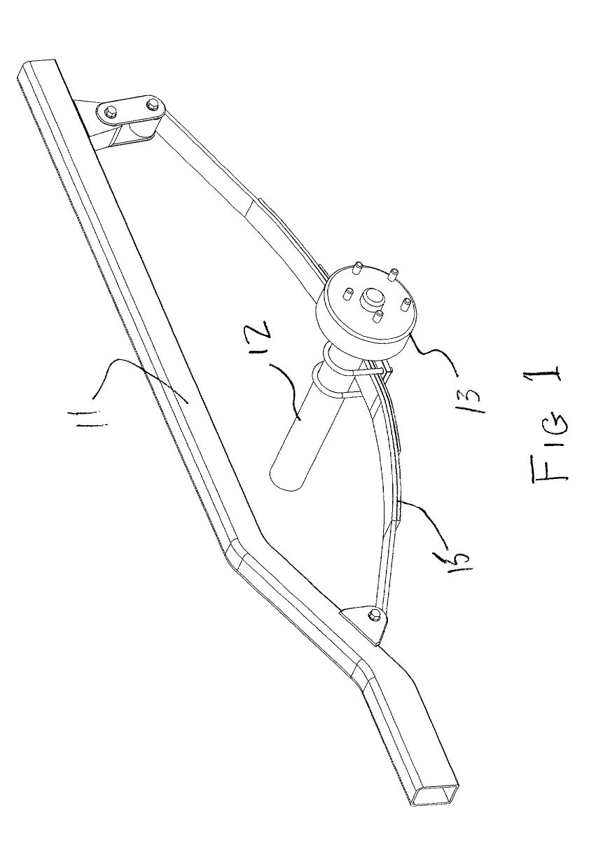

FIG. 1 is a side view in perspective of a part of an axle carried by a shackled leaf spring typically as a truck axle.

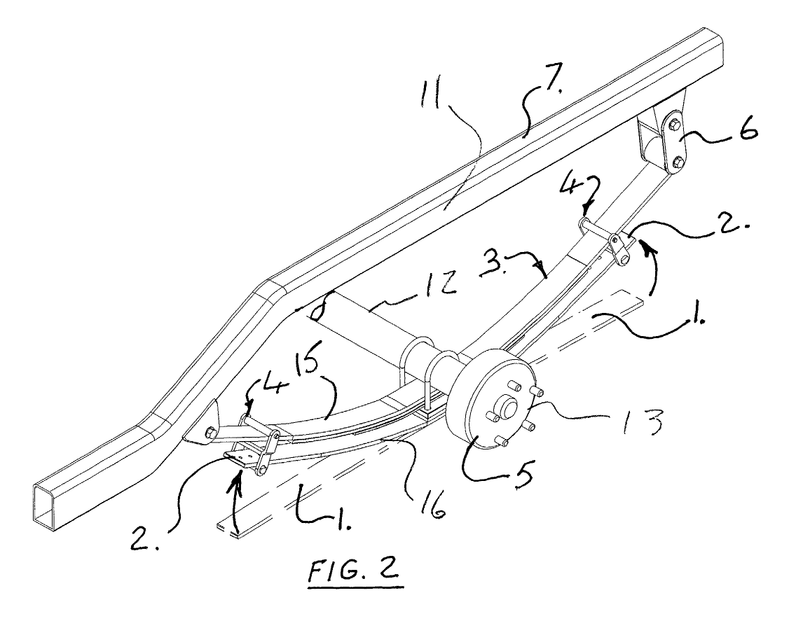

FIG. 2 is a side view in perspective of a part of an axle carried by a shackled leaf spring typically as a truck axle and also a load rebound leaf spring is shown shackled to the jounce leaf spring. In phantom line the unloaded rebound leaf is also shown.

FIG. 3 is a side view in perspective of a part of an axle carried by a shackled leaf spring typically as a truck axle and also a load rebound tension coil spring is shown between the chassis and/or body and the axle support.

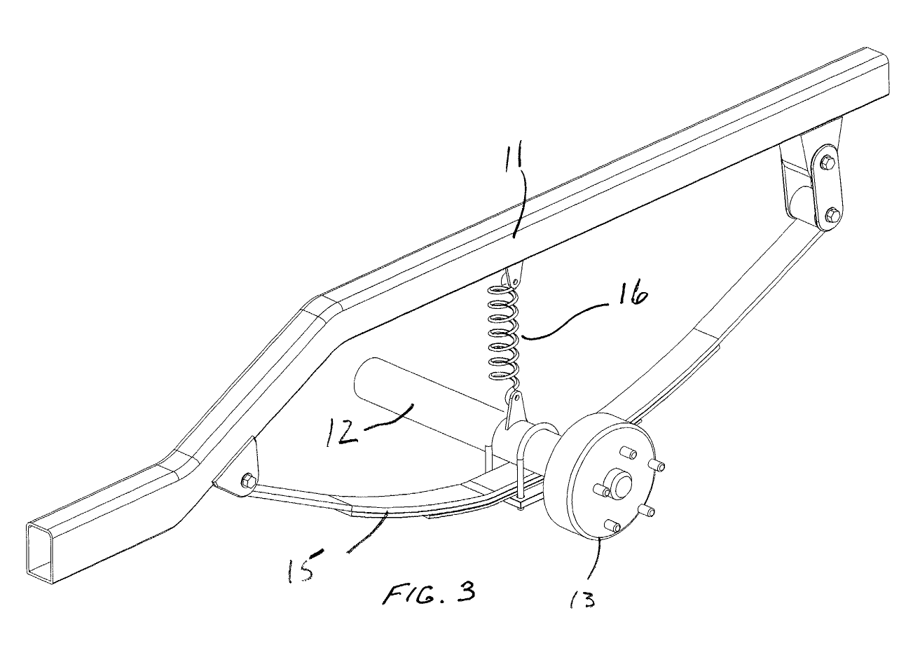

FIG. 4 is a side view in perspective of a part of an axle carried by a shackled leaf spring typically as a truck axle and also a load rebound transversely mounted torsion spring is shown.

FIG. 5 is side view in perspective of a part of an axle carried by a shackled leaf spring typically as a truck axle and also opposed compression springs coaxial with a chassis and/or body rod so separating platform connected to the wheel axle support can control rebound. A shock absorber damper (not shown) can be included with the floating platform.

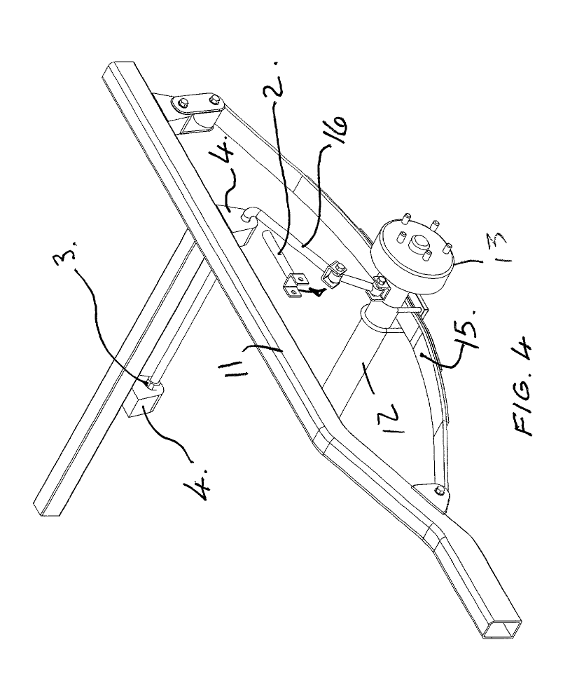

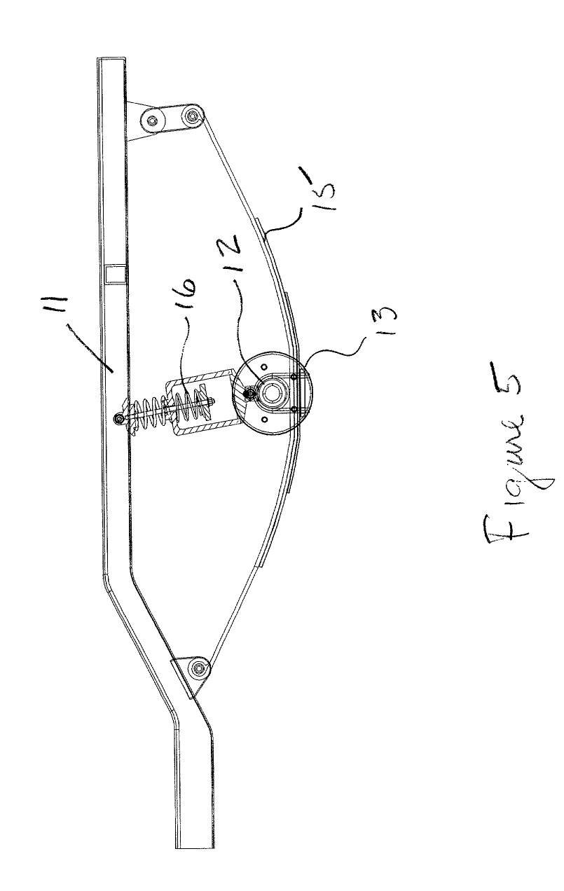

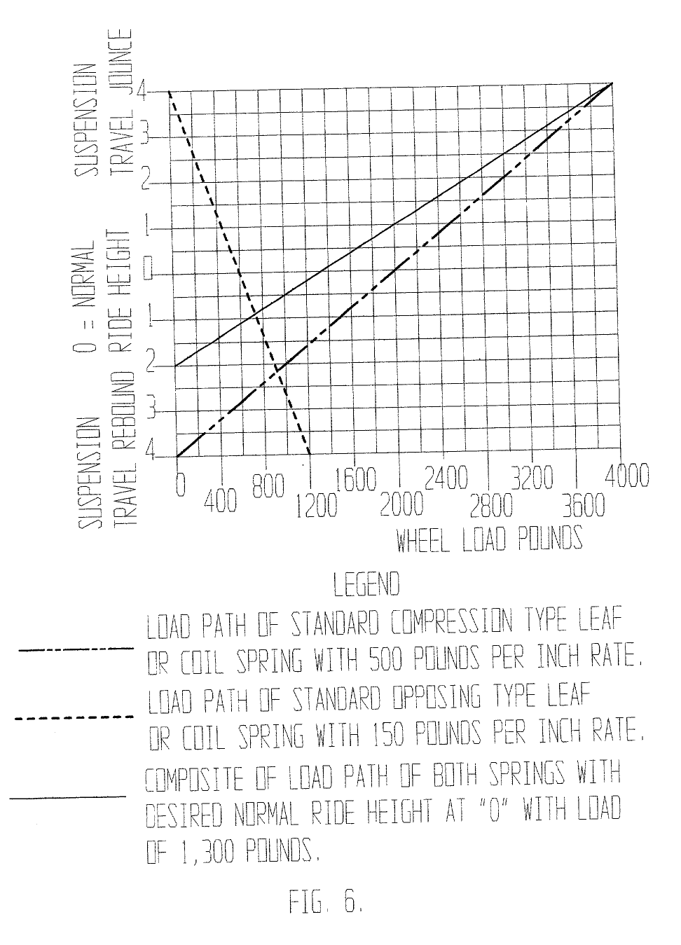

FIG. 6 is a graph showing the force diagrams for the load leaf spring and rebound member over the travel of the wheel axle support relative to the chassis and/or body.

### DETAILED DESCRIPTION OF THE INVENTION

A vehicle spring system 10 is schematically shown in FIG. 1 placed between a chassis and/or body having a sprung weight 11 and a plurality of wheel axle supports 12 each carrying a portion of an unsprung weight 13. As used through this disclosure the term chassis/body 11 refers to that which is carried by each of the one or more the wheel axle supports 12 as sprung weight. An opposed spring system 14 includes a load leaf spring 15 such as for example a coil, air, elastic, torsion or load leaf spring, FIGS. 3 to 11. The load leaf spring 15 mounts between the chassis and/or body 11 and the wheel axle support 12 to carry, when preloaded; the chassis and/or body 11 at a preset ride height relative to the wheel axle support 12.

The load leaf spring 15 mounted between the chassis and/or body and the wheel axle support to carry when preloaded the chassis and/or body at a preset ride height relative to the wheel axle support. Typically, the load leaf spring is parallel to the chassis and/or body 11. Transverse load leaf springs are also common and in so far as those practice the structure disclosed herein they also would be the opposed spring system 14.

A rebound member 16 is affixed between each wheel axle support 12 and the chassis and/or body 11 for exerting increasing force there between as a function of the amount of separating motion of the unsprung weight relative to the chassis and/or body 11. The rebound member 16 mounts to move between the chassis and/or body 11 and the wheel axle support 12. The rebound member 16 applies increasingly less force to load leaf spring 15 during jounce while under loading beyond the pre-load of the chassis and/or body 11 at a preset ride height of the load leaf spring 15. The rebound member 16 applies increasingly more force resisting the separating motion of unsprung weight on the wheel axle support 12. The vehicle spring system 10 has the rebound member 16 with a free length of travel that operates in cooperation with the load leaf spring 15 jounce deflection. Thus, the free length of travel and the jounce deflection overlap when the rebound member moves between the chassis and/or body 11 and the wheel axle support 12.

The vehicle spring system 10 applies to the chassis and/or body 11 having a substantially rectangular footprint of four wheels disposed generally to carry the corners thereof. Each end of the chassis and/or body 11 has corners with at least two wheel of the axle supports 12 moveably carried by respective load leaf springs 15 and rebound members 16 to resist jounce and rebound, respectively. A shock absorber 17 is located between and affixed to the chassis and/or body 11 for each wheel axle support 12 for damping the jounce and rebound motions there between and for progressively decreasing the frequency of the wheel axle support 12 motion. The rebound member 16 is a rebound load leaf spring 18 has its free length of travel preloaded with tension sufficient to maintain its connection between the chassis and/or body 11 and the wheel axle support 12. Even when the load leaf spring 15 is flexed to its maximum load capacity connection remains, see FIG. 2. The rebound member 16 is rebound load tension coil spring 19 in FIG. 3 and has its free length of travel stretched sufficiently between the chassis and/or body 11 and the wheel axle support 12 to attach thereto. Even when the load leaf spring 15 is flexed to its maximum load capacity connection remains. In FIG. 4 a rebound load torsion spring 20 with torque preloaded sufficiently between the chassis and/or body 11 and the wheel axle support 12 to maintain connection there between. Even when the load leaf spring 15 is flexed to its maximum load capacity torque transfer continues. In FIG. 5 the rebound member 16 is part of opposed compression springs 21 coaxial with load axis A-A. Depending from chassis and/or body 11 is a rod 22 and separating platform 23 connected between the chassis and/or body 11 and the wheel axle support 12 to control jounce and rebound in cooperating with the load leaf spring.

The load leaf spring 15 has an elastic constant of K to carry sprung weight on the wheel axle support 12. The rebound member 16 has an elastic constant K_{T} for resisting the rebound separating motion of the sprung weight from the wheel axle support 12. The relationship of the elastic constant of K to carry sprung weight for jounce and the elastic constant K_{T} for resisting the rebound separating motion of the sprung weight is a function of the amount of roll resistance.

The coil tension spring 19 of FIG. 3 is affixed between each wheel axle support 12 and the chassis and/or body 11 for exerting increasing force thereat as a function of the amount of rebound separating motion of the sprung weight relative of the chassis and/or body 11. The coil tension spring 19 mounts relative to the load leaf spring 15 for stretching between the chassis and/or body 11 and the wheel axle support 12. The load leaf spring 15 applies increasingly less rebound force to the load leaf spring 15 during jounce through and beyond the preset ride height as each coil tension spring 19 and resisting the rebound separating motion of sprung weight from the wheel axle support 12. Each coil tension spring 19 is coaxial with load axis A-A in FIG. 3 disposed approximately normal to the chassis and/or body 11 and each wheel axle support 12. The coil tension spring 19 is disposed for movement against the movement of the load leaf spring 15 during rebound.

Each load leaf spring 15 in FIGS. 1 through 5 supports wheel axle support 12 along load axis A-A disposed approximately normal to the chassis and/or body 11 and each wheel axle support 12. Each coil tension spring 18 moves relative to its respective load leaf spring 15 during jounce and rebound.

The vehicle spring system 10 has a plurality of load leaf springs 15 wherein each mounts to permit limited movement along its respective wheel travel relative to the chassis and/or body 11 of each respective wheel axle support 12. A plurality of rebound load leaf springs 18 with each affixed beneath each load leaf spring for exerting increasing force thereat. The force is a function of the amount of rebound motion of the sprung weight relative of the chassis and/or body 11. Each rebound load leaf spring 18 mounts beneath to its respective load leaf spring 15 for flexure there-against. Thus applying increasingly less rebound force to its respective load leaf spring 15 during jounce through and beyond the preset ride height of the load leaf spring 15 as each respective rebound spring 18 resists the rebound motion of sprung weight.

Load axis A-A defines path for the travel between the chassis and/or body 11 and the wheel axle support 12 permitted by each load leaf spring 15 and its respective rebound load leaf spring 18 during jounce and rebound. The rebound load leaf spring 18 has a free length of travel along the path of load axis A-A that operates in cooperation with the load leaf spring 15 jounce deflection therealong. Thus the free length of travel along the path of load axis A-A and the jounce deflection there-along overlap as the load leaf spring 15 moves between the chassis and/or body 11 and the wheel axle support 12. This overlap will be explained in connection with FIG. 6.

Each wheel axle support in FIG. 5 includes rod 22 fixed to the chassis and/or body 11 extending along the load axis A-A path for supporting separating platform 23 dispose in compression for reciprocation along the path with and between the opposed coil springs 24 and 25 during jounce and rebound respectively.

Method of using a vehicle suspension system placed between a chassis and/or body having a sprung weight and a plurality of wheel axle supports each carrying a portion of an unsprung weight, the method having steps comprising:

The chassis and/or body 11 with a substantially rectangular footprint having four wheels disposed generally to carry the corners thereof with each corner having its wheel axle support 12 moveably carried by at least one load leaf springs and respective rebound member to resist jounce and, respectively.

Illustrated on the graph of FIG. 6 the relative opposing spring effects of the load leaf spring 15 and the rebound member 16 are shown with respect to a typical compression load supporting suspension as a solid straight line. The respective travels of each of the load leaf spring 15 and the rebound member 16 overlap giving each its particular control of the wheel axle support 12 movement relative to the chassis/body 11 along the path load axis A-A of its travel. The rebound member 16 mounts to move between the chassis and/or body 11 and the wheel axle support 12 opposite the movement of the load leaf spring 15. The rebound member 16 is located so that it applies increasingly less force to the load leaf spring 15 during jounce beyond the preloaded preset ride height of the load leaf spring 15. Similarly the rebound member 16 increasingly resists the motion of unsprung weight on the wheel axle support 12 as shown by the regularly dashed line in FIG. 6. The sum total of the regularly and irregularly dashed lines shown in FIG. 6 is the solid line depicting the opposing spring influence on the vehicle. Specifically, the solid straight line is the result of the combination of the rebound member 16 load regular dashed line of the load leaf spring 15 and load irregular dashed line of the vehicle support spring. The sum total of the opposing spring suspension uses rebound force applied through the load leaf spring to resist roll, sway of tipping of the vehicle chassis and/or body 11 during cornering as shown in FIG. 6. Note that there is a shift in the slope of the solid line relative to the slope of the irregular dashed line. This is a significant indication that the unsprung weight 13 is resisting the motion of the chassis and/or body 11 away from the wheel axle support 12. Heretofore the suspension designers' goal was to minimize the unsprung weight 13 relative to the sprung weight 11 to reduce momentum effects of the wheel axle support 12 in motion. Thus, no one had thought to use the weight thereof to oppose sway (roll) or pitch of the chassis/body 11. Consequently, the rebound member 16 has a free length of travel that operates in cooperation with the load leaf spring 15 jounce deflection so the free length of travel and the jounce deflection overlap when the rebound member 16 moves between the chassis and/or body 11 and the wheel axle support 12.

The chassis and/or body 11 has a substantially rectangular footprint having four wheels disposed generally to carry the corners thereof with each corner having its wheel axle support 12 moveably carried by its load leaf spring 15 and its rebound member 16 to resist jounce and rebound, respectively.

The rebound member 16 could be a torsion spring 20 as in FIG. 4 with torque preloaded sufficiently between the chassis and/or body 11 and the wheel axle support 12 to maintain connection there between even when the load leaf spring 15, if used, is flexed to its maximum load capacity. Typically torsion spring 20 are pre-twisted to carry the intended static load at a neutral position whereby further load such as jounce will not exceed the ultimate stress and cause permanent deformation of the torsion spring 20 in FIG. 4.

Thus, the concept of overlapping travel as discussed and depicted in the graph of FIG. 6 is not inherent in a single torsion bar or for that matter any other spring suspension even though springs stretched during rebound movement. In FIG. 4 the rebound member 16 is shown as torsion bar with a typical or common pre-twisted and preloaded to carry either jounce or rebound. Skilled spring makers understand how to make such a torsion bars to provide the load or irregular dashed line but not the rebound or solid line in FIG. 6.

The load leaf spring 15 preferably has an elastic constant of K to carry sprung weight on the wheel axle support 12 and the rebound member 16 has an elastic constant K_{T} for resisting the rebound motion of the sprung weight 11 over the wheel axle support 12. The relationship of the elastic constant of K to carry sprung weight 11 for jounce and the elastic constant K_{T} for resisting the rebound motion of the unsprung weight 13 is a function of the amount of roll resistance desired. While a particular example is explained and plotted in FIG. 6, adjustments to the spring constants and travel can be made to adjust for the chassis and/or body 11 load for the ride height and the desired stiffness and travel required.

The vehicle opposed spring system 14 is placed between chassis and/or body 11 as sprung weight and a plurality of wheel axle supports 12 each carrying a portion of an unsprung weight 13. The opposed spring system 14 preferably has load leaf spring 15 mounted between the chassis and/or body 11 and each wheel axle support 12 to carry when preloaded the chassis and/or body 11 at a preset ride height relative to each wheel axle support 12 in FIGS. 1 through 5.

The standard formula for vehicle roll equals:

2×G×Suspension Height/Suspension Width×Spring Load/Spring Rate

In this formula:

G is the gravitational force.

Suspension Height=the distance between the axle center-line and the center of gravity (CG).

Suspension Width equals the distance between spring centers.

In the example calculation below: spring load=800 pounds and spring rate is 100 pounds per inch.

Roll=2×0.75×12/48×800/100=3″ measured at each spring center for a differential of 6 inches. This is equivalent to approximately 3.5 degrees of roll or twist about the roll center. In this example the body rolled as if the vehicle were rounding a curve such that the compressing of the outer spring and the de-compressing of the inner spring were finally neutralized by the centrifugal displacement of the mass.

In the opposed spring system 14 rebound member 16 is positioned along load axis A-A so that rebound spring 16 travels the same path as the wheel axle support 12. For example, rebound member 16 with a rate of 75 pounds per inch deployed so it flexes an equal amount to the load leaf spring 15 travel from its free height reacting against the rebound member 16 a slight amount at normal ride height. Modifying the formula for body roll to include the reaction caused by the rebound member 16.

The formula for roll equals:

2G×Suspension Height/Suspension Weight×2Spring Load/(2K+KT)

Here there are two Spring Rates, K is the load spring rate per inch and KT is the tension spring rate per inch.

The relative reduction in body roll equals 2K/2(K+KT)

and, using the previous example values gives a new resultant body roll of 2.182″

Using this formula:

To reduce the body roll or pitch by 50 percent then KT equals 2K so the roll is halved when the rate of the rebound member 16 equals half the rate of the load leaf spring 15. Subject to the mass of the unsprung weight 13. Thus demonstrating the effectiveness of using opposing springs 14 to offset the rolling mass of the chassis/body 11 above that axle 12 and demonstrating a potential beneficial use of unsprung weight 13.

A method of using the opposed suspension 14 with steps of mounting the load leaf spring 15 between the chassis and/or body and the wheel axle support 12 for carrying it when preloaded a preset ride height, affixing rebound member 16 between each wheel axle support 12 and the chassis and/or body 11 for exerting increasing force there between as a function of the amount of motion of the unsprung weight 13 relative to the chassis and/or body 11, and mounting the rebound member 16 for movement between the chassis and/or body 11 and the wheel axle support 12 while applying increasingly less force to the load leaf spring 15 during jounce while under loading beyond the preloaded at the chassis and/or body 11 preset ride height of the load leaf spring 15 and the rebound member 16 applying increasingly more force resisting the motion of unsprung weight 13 on the wheel axle support 12.

In operation the primary difference, between the opposed spring suspension 14 and existing load carrying spring suspensions, is the involvement of the unsprung mass 13 (i.e. axles/wheels) for controlling the dynamics of the vehicle during cornering. Besides the opposing suspension system 14 at all four corners trying to keep the vehicle level relative to the ground, the unsprung axles now actively participant by virtue of their role as countering mass. Similarly the unsprung masses (front and rear) will also resist forward and aft pitching while braking or accelerating, respectively.

In all the various methods of achieving opposed suspension 14, standard automotive shock absorbers can be incorporated to dampen wheel bounce. The opposing spring suspension 14 is a suspension that is height controlling and has progressive load carrying capability. There are many ways to achieve the resistance to roll of the chassis/body 11 using opposing spring suspension 14.

What is claimed is:

1. A vehicle suspension system placed between a chassis and/or body having a sprung weight and a plurality of wheel axle supports each carrying a portion of an unsprung weight, the vehicle suspension system comprising:
a load leaf spring mounted between the chassis and/or body and a wheel axle support to carry when preloaded the chassis and/or body at a preset ride height relative to the wheel axle support;
a rebound member affixed between each wheel axle support and the chassis and/or body for exerting increasing force there between as a function of the amount of separating motion of the unsprung weight relative to the chassis and/or body, the rebound member mounted to move between the chassis and/or body and the wheel axle support applying increasingly less force to load leaf spring during jounce while under loading beyond the preloaded at the chassis and/or body preset ride height of the load leaf spring and the rebound member applying increasingly more force resisting the separating motion of unsprung weight of the wheel axle support.

2. The vehicle suspension system of claim 1 wherein the rebound member has a free length of travel that operates in cooperation with the load leaf spring jounce deflection so the free length of travel and the jounce deflection overlap when the rebound member moves between the chassis and/or body and the wheel axle support.

3. The vehicle suspension system of claim 1 wherein therein the chassis and/or body has a substantially rectangular footprint with two separate ends, the rectangular footprint including four wheels disposed generally to carry the corners thereof with each end having at least two wheels on their axle supports moveably carried by respective load leaf springs and rebound members to resist jounce and rebound, respectively.

4. The vehicle suspension system of claim 3 wherein therein a shock absorber is located between and affixed to the chassis and/or body for each wheel axle support for damping the jounce and rebound motions there between progressively decreasing the frequency of the wheel axle support motion.

5. The vehicle suspension system of claim 1 wherein the rebound member is a coil spring having its free length of travel preloaded with tension sufficient to maintain its connection between the chassis and/or body and the wheel axle support even when the load leaf spring is flexed to its maximum load capacity.

6. The vehicle suspension system of claim 1 wherein the rebound member is a leaf spring mounted beneath the load leaf spring so as to have its free length of travel flexed sufficiently between the chassis and/or body and the wheel axle support to attach thereto even when the load leaf spring is flexed to its maximum load capacity.

7. The vehicle suspension system of claim 1 wherein the rebound member is a torsion spring mounted transversely relative to the chassis and/or body with torque preloaded sufficiently between the chassis and/or body and the wheel axle support to maintain connection there between even when the load leaf spring is flexed to its maximum load capacity.

8. The vehicle suspension system of claim 1 wherein the load leaf spring has an elastic constant of K to carry sprung weight on the wheel axle support and the rebound member has an elastic constant K_{T} for resisting the rebound separating motion of the sprung weight from the wheel axle support,

9. The vehicle suspension system of claim 8 wherein the relationship of the elastic constant of K to carry sprung weight for jounce and the elastic constant K_{T} for resisting the rebound separating motion of the sprung weight is a function of the amount of roll resistance of the chassis and/or body.

10. A vehicle suspension system placed between a chassis and/or body having a sprung weight and a plurality of wheel axle supports each carrying a portion of an unsprung weight, the vehicle suspension system comprising:
a load leaf spring mounted between the chassis and/or body and each wheel axle support to carry when preloaded the chassis and/or body at a preset ride height relative to the wheel axle support, and
a coil tension spring affixed between each wheel axle support and the chassis and/or body for exerting increasing force thereat as a function of the amount of rebound separating motion of the sprung weight relative of the chassis and/or body, the coil tension spring mounted relative to the load leaf spring for stretching between the chassis and/or body and the wheel axle support to apply increasingly less rebound force to the load leaf spring during jounce through and beyond the preset ride height of the load leaf spring as each coil tension spring resists the rebound separating motion of sprung weight from the wheel axle support.

11. The vehicle suspension system of claim 10 wherein each load leaf spring is coaxial with a load axis disposed approximately normal to the chassis and/or body and each wheel axle support, the coil tension spring disposed for movement against the load leaf spring during rebound.

12. The vehicle suspension system of claim 11 wherein each load leaf spring supports along a load axis disposed approximately normal to the chassis and/or body and each wheel axle support, each coil tension spring moves relative to its respective load leaf spring during jounce and rebound.

13. A vehicle suspension system placed between a chassis and/or body having a sprung weight and a plurality of wheel axle supports each carrying a portion of an unsprung weight generally along as wheel travel for each wheel axle support, the vehicle suspension system comprising:
a plurality of load leaf springs wherein each mounts to permit limited movement along its respective wheel travel relative to the chassis and/or body of each respective wheel axle support so when preloaded the chassis and/or body thereon with a preset ride height relative to each wheel axle support, each load leaf spring operating in flexure under load and jounce, and
a plurality of rebound load leaf springs with each affixed beneath each load leaf spring for exerting increasing force thereat as a function of the amount of rebound motion of the sprung weight relative of the chassis and/or body, each rebound load leaf spring mounted relative to its respective load leaf spring for flexure against the respective load leaf spring to apply increasingly less rebound force to its respective load leaf spring during jounce through and beyond the preset ride height of the load leaf spring as each respective rebound spring resists the rebound motion of sprung weight, and
a path defined by the travel between the chassis and/or body and the wheel axle support permitted by each load leaf spring and its respective rebound load leaf spring during jounce and rebound and wherein the rebound spring has a free length of travel along the path that operates in cooperation with the load leaf spring jounce deflection along the path so the free length of travel along the path and the jounce deflection along the path overlap as the load leaf spring moves between the chassis and/or body and the wheel axle support.

14. The vehicle suspension system of claim 13 wherein each wheel axle support includes a rod fixed to the chassis and/or body extending along the path for supporting a vehicle suspension platform dispose in compression for reciprocation along the path with and between the load leaf spring and the rebound spring during jounce and rebound and the vehicle suspension platform affixed to the wheel axle support.

15. A method of using a vehicle suspension system placed between a chassis and/or body having a sprung weight and a plurality of wheel axle supports each carrying a portion of an unsprung weight, the method having steps comprising:
mounting a load leaf spring between the chassis and/or body and the wheel axle support for carrying when preloaded the chassis and/or body at a preset ride height relative to the wheel axle support;
affixing a rebound member between each wheel axle support and the chassis and/or body for exerting increasing force there between as a function of the amount of separating motion of the unsprung weight relative to the chassis and/or body, and
mounting the rebound member for movement between the chassis and/or body and the wheel axle support while applying increasingly less force to the load leaf spring during jounce while under loading beyond the preloaded at the chassis and/or body preset ride height of the load leaf spring and the rebound member applying increasingly more force resisting the separating motion of unsprung weight from the wheel axle support.

16. The method of claim 15 with the step of having the rebound member with a free length of travel that operates in cooperation with the load leaf spring jounce deflection so the free length of travel and the jounce deflection overlap when the rebound member moves between the chassis and/or body and the wheel axle support.

17. The method of claim 15 with the step of having the chassis and/or body with a front and back end having a substantially rectangular footprint having four wheels disposed generally to carry the ends thereof with each end having its wheel axle support moveably carried by at least two load leaf springs and respective rebound members to resist jounce and, respectively.

18. The method of claim 17 with the step of having a shock absorber is located between and affixed to the chassis and/or body for each wheel axle support for damping the jounce and rebound motions there between progressively decreasing the frequency of the wheel axle support motion.

19. The method of claim 15 with the step of having the rebound member as a coil spring having its free length of travel preloaded with tension sufficient to maintain its connection between the chassis and/or body and the wheel axle support even when the load leaf spring is flexed to its maximum load capacity.

20. The method of claim 15 with the step of having the rebound member as an elastic member having its free length of travel stretched sufficiently between the chassis and/or body and the wheel axle support to attach thereto even when the load leaf spring is flexed to its maximum load capacity.
